(19) United States
(12) Patent Application Publication
(10) Pub. No.: US 2022/0390872 A1
(43) Pub. Date: Dec. 8, 2022

(54) METHOD FOR PRODUCING CAPSULE TONER

(71) Applicant: TOSHIBA TEC KABUSHIKI KAISHA, Tokyo (JP)

(72) Inventors: Takafumi HARA, Sunto Shizuoka (JP); Satoshi ARAKI, Mishima Shizuoka (JP)

(73) Assignee: TOSHIBA TEC KABUSHIKI KAISHA, Tokyo (JP)

(21) Appl. No.: 17/891,036

(22) Filed: Aug. 18, 2022

Related U.S. Application Data
(62) Division of application No. 16/995,671, filed on Aug. 17, 2020.

(51) Int. Cl. G03G 9/093; G03G 9/08

(52) U.S. Cl. CPC G03G 9/09392; G03G 9/0819; G03G 9/09378; G03G 9/09371; G03G 9/09385

(57) ABSTRACT

A method for producing a capsule toner includes preparing core particles; preparing a shell fine particle dispersion liquid having a surface tension of 50 mN/m or more, as measured at 25° C., by dissolving a polyester resin in an organic solvent, thereafter performing neutralization with a neutralizer, and thereafter forming the polyester resin into fine particles; adjusting the surface tension of the shell fine particle dispersion liquid to less than 50 mN/m, as measured at 25° C., by adding a substance that does not include a surfactant to the shell fine particle dispersion liquid; and adhering the shell fine particle dispersion liquid to the surfaces of the core particles. The substance dissolves in or mixes with water and (i) has a vapor pressure equal to or greater than the vapor pressure of water or (ii) has a vapor pressure less than the vapor pressure of water and can be azeotropic with water.

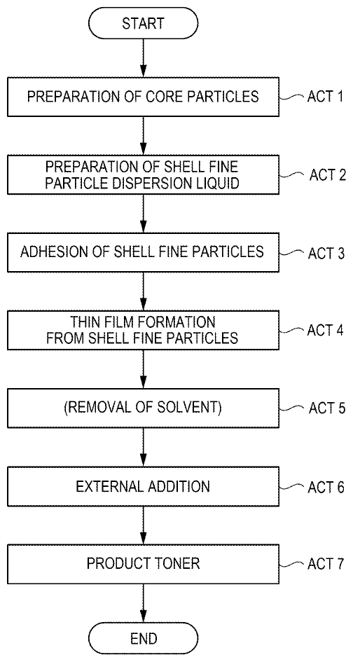

### CROSS-REFERENCE TO RELATED PATENT APPLICATION

This application is a divisional of U.S. patent application Ser. No. 16/995,671, filed Aug. 17, 2020, which is incorporated herein by reference in its entirety.

### FIELD

Embodiments described herein relate generally to a method for producing a capsule toner.

### BACKGROUND

There is a method in which low-temperature fixing is performed using a toner containing a binder resin having a low softening temperature in an image forming apparatus utilizing an electrophotographic method. By performing low-temperature fixing, electric power to be supplied to a fixing device can be suppressed. However, the toner containing a binder resin having a low softening temperature is easily fused by heat, and therefore, blocking resistance is deteriorated.

On the other hand, a capsule toner in which a shell layer is formed on surfaces of core particles enables improvement of blocking resistance without impairing the low-temperature fixability of the toner.

JP 2018-131544 A describes a method for producing a toner including producing a polyester latex dispersion liquid by a method for producing a polyester latex dispersion liquid using a phase inversion emulsification method, and aggregating and fusing at least resin particles contained in the latex dispersion liquid using a solution for forming a toner containing the obtained polyester latex dispersion liquid.

The method for producing a toner described in JP 2018-131544 A needs a washing step for removing a surfactant from toner particles. However, from the viewpoint of improvement of production efficiency of a toner, a method for producing a capsule toner without needing a washing step is demanded.

### DESCRIPTION OF THE DRAWINGS

The FIGURE is a flowchart showing a method for producing a capsule toner according to an embodiment.

### DETAILED DESCRIPTION

An object to be achieved by embodiments is to provide a method for producing a capsule toner having low-temperature fixability and heat resistance and durability at the same time without needing to wash toner particles.

A method for producing a capsule toner according to an embodiment is a method for producing a capsule toner including core particles and a shell layer formed on surfaces of the core particles. Core particles are prepared. A shell fine particle dispersion liquid having a surface tension at 25° C. of 50 mN/m or more is prepared by dissolving a polyester resin in an organic solvent, followed by neutralization with a neutralizer, and then, forming the polyester resin into fine particles by a phase inversion emulsification method. The surface tension at 25° C. of the shell fine particle dispersion liquid is adjusted to less than 50 mN/m by adding a substance (excluding a surfactant), which dissolves in or mixes with water and has a vapor pressure equal to or greater than the vapor pressure of water or has a vapor pressure less than the vapor pressure of water and can be azeotropic with water, to the shell fine particle dispersion liquid. The shell fine particle dispersion liquid is adhered to the surfaces of the core particles.

Hereinafter, the method for producing a capsule toner according to the embodiment will be described in detail. The method for producing a capsule toner according to the embodiment is a method for producing a capsule toner including core particles and a shell layer formed on surfaces of the core particles, and the method includes preparing core particles, preparing a shell fine particle dispersion liquid having a surface tension at 25° C. of 50 mN/m or more by dissolving a polyester resin in an organic solvent, followed by neutralization with a neutralizer, and then, forming the polyester resin into fine particles by a phase inversion emulsification method, adjusting the surface tension at 25° C. of the shell fine particle dispersion liquid to less than 50 mN/m by adding a substance (excluding a surfactant), which dissolves in or mixes with water and has a vapor pressure equal to or greater than the vapor pressure of water or has a vapor pressure less than the vapor pressure of water and can be azeotropic with water, to the shell fine particle dispersion liquid, and adhering the shell fine particle dispersion liquid to the surfaces of the core particles.

Act 1 to Act 7 in parentheses in the following description correspond to Act 1 to Act 7 in the FIGURE, respectively. The order of Act 1 and Act 2 is not limited to the order described herein.

### Preparation of Core Particles (Act 1)

The preparation of core particles (Act 1) includes production of core particles. Hereinafter, the characteristics of the core particles and a method for producing the core particles will be described.

### Characteristics of Core Particles

In the method for producing a capsule toner according to the embodiment, the core particles are not particularly limited, but preferably contain a binder resin, a colorant, and a release agent.

The binder resin is not particularly limited, and a known binder resin for a black toner or a color toner can be used. As the binder resin, either one or both of a crystalline resin and an amorphous resin can be used, however, from the viewpoint of low-temperature fixability, an amorphous resin and a crystalline resin are desirably used together. Examples of the binder resin include a polystyrene resin, a styrene-acrylic copolymer resin, a (meth)acrylic acid ester-based resin, a polyolefin-based resin, a polyester resin, a polyurethane resin, and an epoxy resin, but are not limited thereto. As the binder resin, an amorphous polyester resin and a crystalline polyester resin are preferably used together. As the binder resin, one type can be used by itself or two or more types can be used in combination.

The glass transition temperature of the amorphous resin is not particularly limited, but is preferably between 30 and 80° C., and more preferably between 40 and 70° C. Here, the glass transition temperature is a glass transition temperature measured by performing differential scanning calorimetry according to ISO 3146:2000.

The melting point of the crystalline resin is not particularly limited, but is preferably between 70 and 120° C. Here, the melting point is a melting point measured by performing differential scanning calorimetry according to ISO 3146:2000.

The amount of the binder resin used in the core particles is not particularly limited, but is preferably between 50 and 90 mass %, more preferably between 60 and 90 mass %, and further more preferably between 70 and 90 mass % with respect to the total mass of the core particles.

The colorant is not particularly limited, and a black colorant or a color colorant which is commonly used in the electrophotographic field can be used.

Examples of the black colorant include carbon black, copper oxide, manganese dioxide, aniline black, active carbon, non-magnetic ferrite, magnetic ferrite, and magnetite, but are not limited thereto.

Among the color colorants, examples of a yellow colorant include C.I. Pigment Yellow 12, C.I. Pigment Yellow 13, C.I. Pigment Yellow 14, C.I. Pigment Yellow 15, C.I. Pigment Yellow 17, C.I. Pigment Yellow 74, C.I. Pigment Yellow 93, C.I. Pigment Yellow 94, C.I. Pigment Yellow 138, C.I. Pigment Yellow 180, and C.I. Pigment Yellow 185, but are not limited thereto.

Among the color colorants, examples of a magenta colorant include C.I. Pigment Red 48:1, C.I. Pigment Red 53:1, C.I. Pigment Red 57:1, C.I. Pigment Red 122, C.I. Pigment Red 123, C.I. Pigment Red 139, C.I. Pigment Red 144, C.I. Pigment Red 149, C.I. Pigment Red 166, C.I. Pigment Red 177, C.I. Pigment Red 178, and C.I. Pigment Red 222, but are not limited thereto.

Among the color colorants, examples of a cyan colorant include C.I. Pigment Blue 15, C.I. Pigment Blue 15:2, C.I. Pigment Blue 15:3, C.I. Pigment Blue 16, and C.I. Pigment Blue 60, but are not limited thereto.

The amount of the colorant used in the core particles is not particularly limited, but is preferably between 1 and 20 mass %, and more preferably between 5 and 10 mass % with respect to the total mass of the core particles. The colorant may be used in the form of a master batch in order to uniformly disperse the colorant in the binder resin.

Examples of the release agent include a paraffin wax, a microcrystalline wax, a Fischer-Tropsch wax, a polyethylene wax, a polypropylene wax, a carnauba wax, and a synthetic ester wax, but are not limited thereto.

The melting point of the release agent is not particularly limited, but is preferably between 40 and 100° C., more preferably between 50 and 90° C., and further more preferably within a range between 60 and 80° C. from the viewpoint of low-temperature fixability. Here, the melting point is a melting point measured according to JIS K 2235:2009.

The amount of the release agent used in the core particles is not particularly limited, but is preferably between 1 and 20 mass %, and more preferably between 2 and 10 mass % with respect to the total mass of the core particles.

To the core particles, a charge control agent may be added as needed. As the charge control agent, a charge control agent for positive charge control and a charge control agent for negative charge control that are commonly used in the electrophotographic field can be used.

Examples of the charge control agent for positive charge control include a quaternary ammonium salt, a pyrimidine compound, a triphenylmethane derivative, a guanidine salt, and an amidine salt, but are not limited thereto.

Examples of the charge control agent for negative charge control include a metal-containing azo compound, an azo complex dye, a metal complex and a metal salt (wherein the metal is chromium, zinc, zirconium, or the like) of salicylic acid and a derivative thereof, an organic bentonite compound, and a boron compound, but are not limited thereto.

The amount of the charge control agent used in the core particles is not particularly limited, but is preferably between 0.5 and 3 mass % with respect to the total mass of the core particles.

The volume average particle diameter of the core particles is not particularly limited, but is preferably between 4 and 10 μm. When the volume average particle diameter of the core particles is within this range, an image with higher definition can be more stably formed over a longer period of time. Here, the volume average particle diameter of the core particles is a volume average particle diameter determined by measuring a particle size distribution using a Coulter counter (Multisizer 4e, manufactured by Beckman Coulter, Inc.).

### Method for Producing Core Particles

Examples of a method for producing the core particles include (i) dry methods such as a kneading pulverization method and (ii) wet methods such as a suspension polymerization method, an emulsion aggregation method, a dispersion polymerization method, a dissolution suspension method, and a melt emulsification method, but are not limited thereto. Hereinafter, a method for producing the core particles by a kneading pulverization method will be described.

In the production of the core particles by a pulverization method, core particle raw materials including a binder resin, a colorant, and other additives are mixed by a dry process using a mixer, followed by melt-kneading using a kneader, whereby a melt-kneaded material is obtained. The melt-kneaded material is solidified by cooling, and the solidified material is pulverized using a pulverizer, whereby a finely pulverized material is obtained. Thereafter, the particle size is adjusted by classification or the like as needed, whereby core particles are obtained.

As the mixer, a known mixer can be used, and examples thereof include a Henschel mixer (manufactured by Nippon Coke & Engineering Co., Ltd.) and a Super mixer (manufactured by Kawata MFG. Co., Ltd.), but are not limited thereto. As the kneader, a known kneader can be used, and examples thereof include a twin-screw kneader such as PCM-65/87 (manufactured by Ikegai Corporation) and PCM-30 (manufactured by Ikegai Corporation), and an open-roll kneader such as Kneadex (manufactured by Nippon Coke & Engineering Co., Ltd.), but are not limited thereto. As the pulverizer, a known pulverizer can be used, and examples thereof include Counter jet mill AFG (manufactured by Hosokawa Micron Corporation) that performs pulverization by utilizing a supersonic jet stream, but are not limited thereto. As the classifier, a known classifier can be used, and examples thereof include a rotary classifier TSP separator (manufactured by Hosokawa Micron Corporation), but are not limited thereto.

### Preparation of Shell Fine Particle Dispersion Liquid (Act 2)

In the preparation of a shell fine particle dispersion liquid, the preparation of a shell fine particle dispersion liquid and the adjustment of the surface tension of the shell fine particle dispersion liquid are performed. In the adjustment of the surface tension of the shell fine particle dispersion liquid, a solid content concentration of the shell fine particle dispersion liquid may be adjusted.

The surface tension of the shell fine particle dispersion liquid is a surface tension at 25° C. measured using a surface tension meter (T60-A, manufactured by Meiwafosis Co., Ltd.).

The solid content concentration of the shell fine particle dispersion liquid is a concentration of a residue when the solvent and the dispersion medium of the shell fine particle dispersion liquid are removed.

### Characteristics of Shell Fine Particles

The shell fine particles are fine particles of a polyester resin (polyester resin fine particles). As the polyester resin, either one or both of an amorphous polyester resin and a crystalline polyester resin can be used.

As a monomer constituting the polyester resin, a known monomer can be used, and examples thereof include a polycondensate of a polybasic acid and a polyhydric alcohol.

The polybasic acid is not particularly limited, and a polybasic acid conventionally known as a monomer for a polyester can be used. Specific examples of the polybasic acid include aromatic carboxylic acids such as terephthalic acid, isophthalic acid, phthalic anhydride, trimellitic anhydride, pyromellitic acid, and naphthalene dicarboxylic acid, aliphatic carboxylic acids such as maleic anhydride, fumaric acid, succinic acid, alkenyl succinic anhydride, and adipic acid, and a methyl-esterified product of such a polybasic acid, but are not limited thereto. As the polybasic acid, one type can be used by itself or two or more types can be used in combination.

The polyhydric alcohol is not particularly limited, and a polyhydric alcohol conventionally known as a monomer for a polyester can be used. Specific examples of the polyhydric alcohol include aliphatic polyhydric alcohols such as ethylene glycol, propylene glycol, butanediol, hexanediol, neopentyl glycol, and glycerin, alicyclic polyhydric alcohols such as cyclohexanediol, cyclohexanedimethanol, and hydrogenated bisphenol A, and aromatic diols such as an ethylene oxide adduct of bisphenol A and a propylene oxide adduct of bisphenol A, but are not limited thereto. As the polyhydric alcohol, one type can be used by itself or two or more types can be used in combination.

A polycondensation reaction of the polybasic acid with the polyhydric alcohol can be carried out according to a conventional method. The polycondensation reaction is carried out by, for example, bringing a polybasic acid and a polyhydric alcohol into contact with each other in the presence or absence of an organic solvent and in the presence of a polycondensation catalyst, and the reaction is completed when an acid value, a softening temperature, or the like of a polyester to be produced reached a desired value. In this manner, a polyester is obtained.

When a methyl-esterified product of a polybasic acid is used as a part of the polybasic acid, a demethanol polycondensation reaction is carried out. In the demethanol polycondensation reaction, by appropriately changing the blending ratio of the polybasic acid and the polyhydric alcohol, the reaction rate, or the like, for example, the terminal carboxyl group content of a polyester can be adjusted, and as a result, the properties of a polyester to be obtained can be denatured. In addition, even if trimellitic anhydride is used as the polybasic acid, a carboxyl group can be easily introduced into the main chain of a polyester. By doing this, a denatured polyester is obtained.

The glass transition temperature of the amorphous polyester resin is not particularly limited, but is preferably higher than the glass transition temperature of the core particles, and more preferably between 50 and 100° C. Here, the glass transition temperature is a glass transition temperature measured by performing differential scanning calorimetry according to ISO 3146:2000.

The softening temperature of the amorphous polyester resin is not particularly limited, but is preferably higher than the softening temperature of the core particles, and more preferably between 80 and 140° C. Here, the softening temperature is a Vicat softening temperature measured according to ISO 306:2003.

The melting point of the crystalline polyester resin is not particularly limited, but is preferably higher than the melting point of the binder resin to be used for the core particles, and more preferably between 90 and 150° C. Here, the melting point is a melting point measured by performing differential scanning calorimetry according to ISO 3146:2000.

The volume average particle diameter of the shell fine particles (polyester resin fine particles) is not particularly limited, but is preferably sufficiently smaller than the volume average particle diameter of the core particles, and more preferably between 10 and 100 nm. Here, the volume average particle diameter of the shell fine particles (polyester resin fine particles) is a volume average particle diameter determined by subjecting the shell fine particle dispersion liquid to measurement of the particle size distribution using a laser diffraction particle size distribution analyzer (SALD-7500nano, manufactured by Shimadzu Corporation).

### Preparation of Shell Fine Particle Dispersion Liquid

The preparation of a shell fine particle dispersion liquid is performed by dissolving a polyester resin in an organic solvent, followed by neutralization with a neutralizer, and then, forming the polyester resin into fine particles by a phase inversion emulsification method.

When the polyester resin is dissolved in the organic solvent, the polyester resin is preferably added to the organic solvent while stirring the organic solvent in a container.

When the solution obtained by dissolving the polyester resin in the organic solvent (hereinafter referred to as “polyester resin solution”) is neutralized, the neutralizer is preferably added to the polyester resin solution while stirring the polyester resin solution in a container. The neutralizer is preferably added in the form of an aqueous solution to the polyester resin solution.

The organic solvent is not particularly limited as long as the organic solvent can dissolve the polyester resin. Examples of the organic solvent include tetrahydrofuran, acetone, and ethyl acetate, but are not limited thereto. As the organic solvent, at least one type selected from the group consisting of tetrahydrofuran, acetone, and ethyl acetate is preferred. As the organic solvent, one type can be used by itself or two or more types can be used in combination.

The neutralizer is not particularly limited as long as the neutralizer can neutralize an acid. As the neutralizer, a Bronsted base or a Lewis base is preferred, and examples thereof include sodium hydroxide, potassium hydroxide, ammonia, and an organic amine compound, but are not limited thereto. As the neutralizer, at least one type selected from the group consisting of sodium hydroxide, potassium hydroxide, ammonia, and an organic amine compound is preferred. The neutralizer may be used in the form of an aqueous solution. As the neutralizer, one type can be used by itself or two or more types can be used in combination.

The phase inversion emulsification method is not particularly limited, and can be performed by a conventionally known method. In the phase inversion emulsification method, specifically, an Oil in Water emulsion is preferably formed by adding an aqueous solution of a neutralizer and water (aqueous phase) to a polyester resin solution (oil phase) obtained by dissolving a polyester resin in an organic solvent and inverting a continuous phase from the oil phase to the aqueous phase. In addition, the organic solvent is desirably removed as needed. By the phase inversion emulsification method, an aqueous dispersion liquid in which the shell fine particles of a polyester resin are uniformly dispersed in water is obtained.

The surface tension at 25° C. of the prepared shell fine particle dispersion liquid is generally 50 mN/m or more.

### Adjustment of Surface Tension of Shell Fine Particle Dispersion Liquid and Adjustment of Solid Content Concentration

The adjustment of the surface tension of the shell fine particle dispersion liquid is performed by adding a substance (excluding a surfactant), which dissolves in or mixes with water and has a vapor pressure equal to or greater than the vapor pressure of water or has a vapor pressure less than the vapor pressure of water and can be azeotropic with water (hereinafter referred to as “surface tension adjusting substance”), to the shell fine particle dispersion liquid prepared as described above, thereby adjusting the surface tension at 25° C. to less than 50 mN/m.

In the addition of the surface tension adjusting substance to the shell fine particle dispersion liquid, the surface tension adjusting substance is preferably added while stirring the shell fine particle dispersion liquid in a container.

The surface tension adjusting substance is not particularly limited as long as the surface tension adjusting substance is a substance (excluding a surfactant), which dissolves in or mixes with water and has a vapor pressure equal to or greater than the vapor pressure of water or has a vapor pressure less than the vapor pressure of water and can be azeotropic with water. Examples of the surface tension adjusting substance include ethanol, methanol, n-propanol, and isopropyl alcohol, but are not limited thereto. As the surface tension adjusting substance, at least one type selected from the group consisting of ethanol, methanol, n-propanol, and isopropyl alcohol is preferred.

As the surface tension adjusting substance, one type can be used by itself or two or more types can be used in combination.

The solid content concentration may be adjusted by adding water to the shell fine particle dispersion liquid before and after the addition of the surface tension adjusting substance, or simultaneously with the addition.

The surface tension at 25° C. of the shell fine particle dispersion liquid after the surface tension and the solid content concentration are adjusted and immediately before the dispersion liquid is adhered to the core particles is less than 50 mN/m, preferably 45 mN/m or less, and more preferably 40 mN/m or less. The lower limit of the surface tension at 25° C. of the shell fine particle dispersion liquid immediately before the dispersion liquid is adhered to the core particles is not particularly limited, but is generally 30 mN/m.

The solid content concentration of the shell fine particle dispersion liquid after the surface tension and the solid content concentration are adjusted and immediately before the dispersion liquid is adhered to the core particles is not particularly limited, but is preferably between 1 and 50 mass %, more preferably between 1 and 30 mass %, and further more preferably between 1 and 15 mass %.

The shell fine particle dispersion liquid after the surface tension and the solid content concentration are adjusted does not contain a surfactant. In addition, the shell fine particle dispersion liquid immediately after the dispersion liquid is prepared by the phase inversion emulsification method also does not contain a surfactant.

### Adhesion of Shell Fine Particles (Act 3)

The shell fine particle dispersion liquid is adhered to the core particles. By doing this, the shell fine particles are adhered to the surfaces of the core particles. As a method for adhering the shell fine particle dispersion liquid to the surfaces of the core particles, various methods such as a method in which the shell fine particle dispersion liquid is sprayed on the core particles, and a method in which the core particles and an aqueous dispersion of the shell fine particles are mixed can be utilized, but the shell fine particle dispersion liquid is preferably sprayed while stirring the dried core particles. It is preferred to further perform stirring after the shell fine particle dispersion liquid is sprayed.

The ratio of the core particles to the shell fine particles is not particularly limited, but the adhesion amount of the shell fine particles with respect to 100 parts by mass of the core particles is preferably between 1 and 50 parts by mass, and more preferably between 1 and 25 parts by mass.

The water content ratio immediately after the shell fine particle dispersion liquid is sprayed on the core particles is not particularly limited, but is preferably between 1 and 30 mass % with respect to the total mass of the core particles and the shell fine particles.

### Thin Film Formation from Shell Fine Particles (Act 4)

After the shell fine particles are adhered to the core particles, the shell fine particles adhered to the core particles are formed into a thin film or shell. The thin film formation from the shell fine particles adhered to the core particles is performed by forming the shell fine particles into a film on the surfaces of the core particles by stirring wet composite particles obtained by adhering the shell fine particle dispersion liquid to the core particles. Examples of a device that stirs the wet composite particles include a stirring device such as a multi-purpose mixer, but are not limited thereto.

### Removal of Solvent (Act 5)

After the thin film formation from the shell fine particles is performed, the solvent and water are removed. The removal of the solvent and water is preferably performed by decompressing the inside of the system while stirring the core shell particles resulting from the thin film formation from the shell fine particles on the surfaces of the core particles. In order to decompress the inside of the system while stirring the core shell particles, for example, a high-speed vacuum dryer (manufactured by EARTHTECHNICA Co., Ltd.) can be used, but the device is not limited thereto. By the removal of the solvent and water, capsule toner particles are obtained. In the removal of the solvent and water, the removal is desirably performed until the amount of water measured by a heat-drying type moisture meter becomes less than 1%.

### External Addition (Act 6)

In the method for producing a capsule toner according to the embodiment, an external addition operation in which an external additive is adhered to the surfaces of the capsule toner particles may be further performed by mixing the obtained capsule toner particles and the external additive using a mixer.

As the external additive, a conventionally known external additive to be used for the production of a capsule toner can be used. Examples of the external additive include silica fine particles and titanium oxide fine particles subjected to a hydrophobization treatment with a silane coupling agent, but are not limited thereto. The volume average particle diameter of the external additive is not particularly limited, but is preferably between 5 and 20 nm. As the external additive, one type can be used by itself or two or more types can be used in combination.

As the mixer, a conventionally known mixer to be used for the production of a capsule toner can be used. Examples of the mixer include a Henschel mixer (brand name, manufactured by Nippon Coke & Engineering Co., Ltd.) and a Super mixer (brand name, manufactured by Kawata MFG. Co., Ltd.), but are not limited thereto.

### Product Toner (Act 7)

By performing the above-mentioned processes, a product toner is obtained. Since a surfactant is not used in the preparation of the shell fine particle dispersion liquid, there is no need to remove a surfactant by water washing unlike a conventional method for producing a capsule toner. Therefore, the method for producing a capsule toner according to the embodiment can significantly reduce the amount of washing water used as compared with a conventional method for producing a capsule toner. Since the amount of washing water used can be reduced, the amount of discharged water can also be reduced. Therefore, the method for producing a capsule toner according to the embodiment not only has an advantageous characteristic that the cost is low, but also has an advantageous characteristic that the environmental load is low.

Further, a capsule toner produced by the method for producing a capsule toner according to the embodiment has excellent low-temperature fixability and excellent heat resistance and durability as shown in the below-mentioned Examples.

While certain embodiments have been described, these embodiments have been presented by way of example only, and are not intended to limit the scope of the invention. The embodiments described herein may be embodied in a variety of other forms, and various omissions, substitutions, and changes may be made without departing from the gist of the invention. The embodiments or modifications thereof are included in the scope or gist of the invention and also included in the invention described in the claims and in the scope of their equivalents.

### EXAMPLES

Hereinafter, the embodiments will be more specifically described by way of Examples. However, needless to say, the embodiments are not limited to the below-mentioned Examples.

### Production Example of Core Particles

Core particles including 70 Parts by mass of an amorphous polyester resin (glass transition temperature: 58° C.), 10 parts by mass of a crystalline polyester resin (melting point: 110° C.), 10 parts by mass of carbon black, and 10 parts by mass of a paraffin wax (melting point: 72° C.) were uniformly mixed using a Henschel mixer, followed by melt-kneading. After melt-kneading, the core particles were pulverized and classified, whereby core particles A were obtained. The volume average particle diameter of the core particles A measured by the below-mentioned method was 6.5 μm.

### Production Example of Shell Fine Particle Dispersion Liquid

520 Parts by mass of tetrahydrofuran was placed in a 3000 cc flask. 280 Parts by mass of an amorphous polyester resin (glass transition temperature: 68° C.) was added to the tetrahydrofuran while stirring. After the amorphous polyester resin was added to the tetrahydrofuran, the temperature in the flask was maintained at 25° C. for 2 hours, whereby a polyester resin solution was prepared.

To the prepared polyester resin solution, 20 g of an aqueous solution of sodium hydroxide at a concentration of 30% (30 g/100 mL) was added, and the resulting mixture was maintained with stirring for 30 minutes, whereby the polyester resin was neutralized. Further, to the neutralized polyester resin solution, 1380 parts by mass of pure water was added at a rate of 10 g/min, whereby a polyester resin-containing slurry was obtained. The obtained polyester resin-containing slurry was maintained at 50° C. for 6 hours while stirring to remove tetrahydrofuran, whereby a shell fine particle dispersion liquid A was obtained.

The volume average particle diameter of the polyester resin fine particles in the shell fine particle dispersion liquid A measured by the below-mentioned method was 33 nm. Further, the surface tension of the shell fine particle dispersion liquid A measured by the below-mentioned method was 58.5 mN/m at 25° C.

### Example 1

A shell fine particle dispersion liquid A1 was produced by adding pure water and ethanol so that the solid content concentration of the shell fine particle dispersion liquid A was 10 mass % and the surface tension was 45 mN/m.

500 Parts by mass of the core particles A were placed in a multi-purpose mixer equipped with a 6.5 L standard tank, and stirred at 1500 rpm.

To a mixing field where the core particles A were stirred, 100 parts by mass of the shell fine particle dispersion liquid A1 was added by utilizing a spray nozzle, and the resulting mixture was maintained with stirring for 10 minutes, whereby the shell fine particles were adhered to the surfaces of the core particles A. Subsequently, the rotational speed of the multi-purpose mixer was changed to 5500 rpm, and stirring was further continued for 10 minutes, whereby the shell fine particles were uniformly adhered to the surfaces of the core particles A.

Subsequently, the rotational speed of the multi-purpose mixer was changed to 8500 rpm, whereby the shell fine particles adhered to the surfaces of the core particles A were formed into a thin film.

Subsequently, the rotational speed of the multi-purpose mixer was decreased to 1500 rpm, and the inside of the system was decompressed to dry the resultant until the water content ratio was decreased to less than 1 mass %, whereby capsule toner particles 1 were obtained.

When the particle size distribution of the obtained capsule toner particles 1 was measured, the volume average particle diameter was 6.6 μm, and a uniform particle size distribution without fine particles was obtained. Further, when the surface of the capsule toner particle 1 was observed with a scanning electron microscope, a uniform film was formed, and fine particles or the like could not be confirmed.

To 100 parts by mass of the capsule toner particles 1, 2 parts by mass of hydrophobic silica and 0.5 parts by mass of titanium oxide were added to adhere hydrophobic silica and titanium oxide to the surfaces of the capsule toner particles, whereby a toner 1 was produced.

### Comparative Example 1

A shell fine particle dispersion liquid A2 was produced by adding pure water so that the solid content concentration of the shell fine particle dispersion liquid A was 10 mass %. The surface tension of the shell fine particle dispersion liquid A2 was 64.5 mN/m at 25° C.

Capsule toner particles 2 were obtained in the same manner as in Example 1 except that the shell fine particle dispersion liquid A1 was changed to the shell fine particle dispersion liquid A2.

When the particle size distribution of the obtained capsule toner particles 2 was measured, a particle size distribution having two peaks at 6.5 μm and 2.0 μm was obtained. Further, when the surface of the capsule toner particle 2 was observed with a scanning electron microscope, a uniform film was partially formed, but many aggregate particles or spheres with a size of about 2 μm appeared to be adhered.

To 100 parts by mass of the capsule toner particles 2, 2 parts by mass of hydrophobic silica and 0.5 parts by mass of titanium oxide were added to adhere hydrophobic silica and titanium oxide to the surfaces of the capsule toner particles, whereby a toner 2 was produced.

### Example 2

A shell fine particle dispersion liquid A3 was produced by adding pure water and ethanol so that the solid content concentration of the shell fine particle dispersion liquid A was 10 mass % and the surface tension was 40 mN/m.

Capsule toner particles 3 were obtained in the same manner as in Example 1 except that the shell fine particle dispersion liquid A1 was changed to the shell fine particle dispersion liquid A3.

When the particle size distribution of the obtained capsule toner particles 3 was measured, the volume average particle diameter was 6.6 μm, and a uniform particle size distribution without fine particles was obtained. Further, when the surface of the capsule toner particle 3 was observed with a scanning electron microscope, a uniform film was formed, and fine particles or the like could not be confirmed.

To 100 parts by mass of the capsule toner particles 3, 2 parts by mass of hydrophobic silica and 0.5 parts by mass of titanium oxide were added to adhere hydrophobic silica and titanium oxide to the surfaces of the capsule toner particles, whereby a toner 3 was produced.

### Comparative Example 2

A shell fine particle dispersion liquid A4 was produced by adding pure water and ethanol so that the solid content concentration of the shell fine particle dispersion liquid A was 10 mass % and the surface tension was 50 mN/m.

Capsule toner particles 4 were obtained in the same manner as in Example 1 except that the shell fine particle dispersion liquid A1 was changed to the shell fine particle dispersion liquid A4.

When the particle size distribution of the obtained capsule toner particles 4 was measured, a particle size distribution having two peaks at 6.5 μm and 2.0 μm was obtained. Further, when the surface of the capsule toner particle 4 was observed with a scanning electron microscope, a uniform film was partially formed, but many aggregate particles or spheres with a size of about 2 μm appeared to be adhered.

To 100 parts by mass of the capsule toner particles 4, 2 parts by mass of hydrophobic silica and 0.5 parts by mass of titanium oxide were added to adhere hydrophobic silica and titanium oxide to the surfaces of the capsule toner particles, whereby a toner 4 was produced.

### Measurement Methods for Particle Size Distribution and Volume Average Particle Diameter

After 1 g of a powder was dispersed in 99 g of an aqueous solution of a surfactant at a concentration of 1 mass %, a particle size distribution was measured using a particle size distribution analyzer (Multisizer 3, manufactured by Beckman Coulter, Inc.), and the volume average particle diameter of the powder was determined.

### Evaluation of Low-Temperature Fixability and Heat Resistance and Durability

### Preparation of Developer

A ferrite carrier coated with a silicone resin and a toner were mixed so that a toner ratio concentration was 8%, whereby a developer was prepared.

### Low-Temperature Fixability

The produced developer was placed in a multifunction printer (e-studio 4520c, manufactured by Toshiba Tec Corporation) modified so that an unfixed image can be collected, and a solid image was collected so that a toner adhesion amount was 1.2 mg/cm2 on paper with a basis weight of 80 g/m2 in a normal temperature and normal humidity atmosphere. The collected image was fixed at a paper feed rate of 200 mm/sec with a fixing device modified so that the fixing temperature can be freely changed, and the lowest fixing temperature at which fixing can be carried out was measured. The lowest fixing temperature is shown in Table 1. When the lowest fixing temperature is 120° C. or lower, the low-temperature fixability is excellent.

### Heat Resistance and Durability

The produced developer was placed in a developing unit of a multifunction printer (e-studio 4520c, manufactured by Toshiba Tec Corporation), and the number of streak images of a half-tone image, which was output after only the developing unit was continuously driven for 6 hours in a thermoregulated bath at 35° C. so as not to be developed on a photoconductor, was counted.

The evaluation criteria were as follows. The number of streak images was 0: A (heat resistance and durability are excellent). The number of streak images was 1 or more: D (heat resistance and durability are poor). The number of streak images and evaluation are shown in Table 1.

### Comprehensive Evaluation

One having excellent low-temperature fixability and excellent heat resistance and durability was evaluated as A (superior overall) and the others were evaluated as D (inferior overall).

TABLE 1

| | | | Compar- | | Compar- |
|---|---|---|---|---|---|
| | | Exam- | ative | Exam- | ative |
| | | ple 1 | Example 1 | ple 2 | Example 2 |
| Toner | | 1 | 2 | 3 | 4 |
| Low- | Lowest fixing | 112 | 112 | 112 | 112 |
| temperature | temperature | | | | |
| fixability | [° C.] | | | | |
| Heat resis- | Streak images | 0 | 7 | 0 | 3 |
| tance and | [number] | | | | |
| durability | Evaluation | A | D | A | D |

| | | | | |
|---|---|---|---|---|
| Comprehensive Evaluation | A | D | A | D |

In any of the above-mentioned Examples and Comparative Examples, a surfactant was not used when the shell fine particle dispersion liquid was prepared.

As shown in Table 1, the toner 1 of Example 1 and the toner 3 of Example 2 had excellent low-temperature fixability and excellent heat resistance and durability, and were superior overall (Comprehensive Evaluation: A). On the other hand, the toner 2 of Comparative Example 1 and the toner 4 of Comparative Example 2 had poor heat resistance and durability, and were inferior overall (Comprehensive Evaluation: D).

While certain embodiments have been described these embodiments have been presented by way of example only, and are not intended to limit the scope of the inventions. Indeed, the novel embodiments described herein may be embodied in a variety of other forms: furthermore various omissions, substitutions and changes in the form of the embodiments described herein may be made without departing from the spirit of the inventions. The accompanying claims and there equivalents are intended to cover such forms or modifications as would fall within the scope and spirit of the invention.

What is claimed is:

1. A method for producing a capsule toner including core particles and a shell layer formed on surfaces of the core particles, the method comprising:
preparing the core particles;
preparing a shell fine particle dispersion liquid that forms the shell layer, which includes:
preparing an initial shell fine particle dispersion liquid having a surface tension of 50 mN/m or more, as measured at 25° C., including (i) dissolving a polyester resin in an organic solvent, thereafter (ii) performing neutralization with a neutralizer, and thereafter (iii) forming the polyester resin into fine particles; and
adjusting the surface tension of the initial shell fine particle dispersion liquid to less than 50 mN/m, as measured at 25° C., by adding a substance to the initial shell fine particle dispersion liquid to provide the shell fine particle dispersion liquid, wherein the substance dissolves in or mixes with water and (i) has a vapor pressure equal to or greater than the vapor pressure of water or (ii) has a vapor pressure less than the vapor pressure of water and can be azeotropic with water, and wherein the shell fine particle dispersion liquid does not contain a surfactant; and
adhering the shell fine particle dispersion liquid to the surfaces of the core particles including mixing the shell fine particle dispersion liquid and the core particles using aqueous dispersion.

2. The method of claim 1, wherein a solid content concentration of the initial shell fine particle dispersion liquid is adjusted to 1 to 50 mass % when the surface tension of the initial shell fine particle dispersion liquid is adjusted to less than 50 mN/m, as measured at 25° C.

3. The method of claim 2, wherein the adjusting the solid content concentration of the initial shell fine particle dispersion liquid includes adding water to the initial shell fine particle dispersion liquid.

4. The method of claim 3, further comprising removing the organic solvent and the water until an amount of the water measured by a heat-drying type moisture meter becomes less than 1% to provide capsule toner particles without having to perform a washing step.

5. The method of claim 1, wherein the initial shell fine particle dispersion liquid is adjusted to less than 45 mN/m and greater than 30 mN/m, as measured at 25° C., by adding the sub stance.

6. The method of claim 1, wherein the fine particles in the initial shell fine particle dispersion liquid have a volume average particle diameter of 10 nm to 100 nm, wherein the volume average particle diameter is measured with a laser diffraction particle size distribution analyzer.

7. The method of claim 1, wherein the core particles have a volume average particle diameter of 4 μm to 10 μm, wherein the volume average particle diameter is measured with a Coulter counter.

8. The method of claim 1, wherein the core particles include carbon black in an amount of 1% to 20% with respect to the total mass of the core particles.

9. The method of claim 8, wherein the core particles include an amorphous polyester resin and a crystalline polyester resin.

10. The method of claim 1, wherein the core particles include a binder resin, a colorant, and a release agent, wherein the binder resin includes at least one of a crystalline resin or an amorphous resin, wherein the colorant includes at least one of a black colorant or a color colorant, and wherein the release agent includes at least one of a paraffin wax, a microcrystalline wax, a Fischer-Tropsch wax, a polyethylene wax, a polypropylene wax, a carnauba wax, or a synthetic ester wax.

11. The method of claim 10, wherein the binder resin is between 50% and 90% with respect to the total mass of the core particles, wherein the colorant is between 1% and 20% with respect to the total mass of the core particles, and wherein the release agent is between 1% and 20% with respect to the total mass of the core particles.

12. The method of claim 11, wherein the binder resin is between 70% and 90% with respect to the total mass of the core particles, wherein the colorant is between 5% and 10% with respect to the total mass of the core particles, and wherein the release agent is between 2% and 10% with respect to the total mass of the core particles.

13. The method of claim 11, wherein the core particles include a charge control agent including at least one of a quaternary ammonium salt, a pyrimidine compound, a triphenylmethane derivative, a guanidine salt, or an amidine salt, and wherein the charge control agent is between 0.5% and 3% with respect to the total mass of the core particles.

14. The method of claim 1, wherein forming the polyester resin into the fine particles is performed using a phase inversion emulsification process.

15. The method of claim 1, wherein the organic solvent is at least one type selected from the group consisting of tetrahydrofuran, acetone, and ethyl acetate, wherein the substance is at least one type selected from the group consisting of ethanol, methanol, n-propanol, and isopropyl alcohol, and wherein the neutralizer is at least one type selected from the group consisting of sodium hydroxide, potassium hydroxide, ammonia, and an organic amine compound.

16. The method of claim 1, wherein:
the core particles include a binder resin, a colorant, and a release agent;
the binder resin is between 70% and 90% with respect to the total mass of the core particles;
the binder resin includes at least one of a crystalline resin or an amorphous resin;
the colorant is between 5% and 10% with respect to the total mass of the core particles;
the colorant includes at least one of a black colorant or a color colorant;
the release agent is between 2% and 10% with respect to the total mass of the core particles;
the release agent includes at least one of a paraffin wax, a microcrystalline wax, a Fischer-Tropsch wax, a polyethylene wax, a polypropylene wax, a carnauba wax, or a synthetic ester wax;
the core particles have a first average particle diameter of between 4 μm and 10 μm; and
the fine particles have a second average particle diameter between 10 nm and 100 nm.

17. A method for producing a capsule toner, the method comprising:
preparing a shell fine particle dispersion liquid having a first surface tension, wherein the first surface tension is 50 mN/m or more, as measured at 25° C.;
adjusting the first surface tension of the shell fine particle dispersion liquid to a second surface tension by adding a substance to the shell fine particle dispersion liquid, wherein the second surface tension is less than 45 mN/m, as measured at 25° C., and wherein the shell fine particle dispersion liquid does not contain a surfactant; and
adhering the shell fine particle dispersion liquid to surfaces of core particles including by mixing the shell fine particle dispersion liquid and the core particles using aqueous dispersion.

18. The method of claim 17, wherein:
the core particles include a binder resin, a colorant, and a release agent;
the binder resin is between 70% and 90% with respect to the total mass of the core particles;
the binder resin includes at least one of a crystalline resin or an amorphous resin;
the colorant is between 5% and 10% with respect to the total mass of the core particles;
the colorant includes at least one of a black colorant or a color colorant;
the release agent is between 2% and 10% with respect to the total mass of the core particles;
the release agent includes at least one of a paraffin wax, a microcrystalline wax, a Fischer-Tropsch wax, a polyethylene wax, a polypropylene wax, a carnauba wax, or a synthetic ester wax; and
the core particles have an average particle diameter of between 4 μm and 10 μm.

19. The method of claim 17, wherein the second surface tension of the shell fine particle dispersion liquid is less than 45 mN/m, but greater than 30 mN/m, as measured at 25° C., by adding the substance.
